(19) United States
(12) Patent Application Publication
(10) Pub. No.: US 2011/0040599 A1
(43) Pub. Date: Feb. 17, 2011

(54) TECHNIQUES FOR SCHEDULING MEETING RESOURCES IN CALENDAR SYSTEMS

(76) Inventors: Meena Guruprasad, Bangalore (IN); Hema Joshi, Bangalore (IN); Smita R. Talashikar, Bangalore (IN)

Correspondence Address: SCHWEGMAN, LUNDBERG & WOESSNER/NOVELL, PO BOX 2938, MINNEAPOLIS, MN, 55402, US

(21) Appl. No.: 12/540,984

(22) Filed: Aug. 13, 2009

(51) Int. Cl. G06Q 10/00; G06F 15/16

(52) U.S. Cl. 705/9; 709/204

(57) ABSTRACT

Techniques for scheduling meeting resources within calendar systems are presented. Non-human resources are made available for scheduling within a calendar system. As these meeting resources are identified within the calendar system a background search is performed to determine their availability for a proposed meeting that has not yet been scheduled. The status of availability for the meeting resources are communicated within the calendar system to a meeting organizer.

### BACKGROUND

Scheduling meetings via email clients is not intuitive or easy for email users. Typically, when a user attempts to schedule a meeting with other users, the scheduling user needs to do a calendar search to determine whether a desired meeting room being requested is available at the time and date desired by the user. This is clumsy and time consuming for the user.

Moreover, meeting rooms are not the only kind of resources that users generally need to conduct a meeting. For example, a user may need an overhead projector; may need Internet connectivity; may need video conferencing equipment; etc. Conventional calendar systems may or may not provide reservations for meeting rooms but generally conventional calendar systems do not provide reservation capabilities for these other types of resources; and yet, in many instances these other types of resources are equally as important to the users as the meeting rooms are for the meetings.

Thus, what are needed are improved techniques for scheduling meeting resources within calendar systems.

### SUMMARY

In various embodiments, techniques for scheduling meeting resources in calendar systems are presented. More specifically, and in an embodiment, a method facilitating the scheduling of meeting resources within a calendar system. That is, a meeting resource is noted in a proposed meeting and a background search is conducted to determine whether the meeting resource identified in the proposed meeting is available for use at a proposed date and at a proposed time defined in the proposed meeting. Next, a meeting organizer for the proposed meeting is notified as to a status of availability for the meeting resource based on the background search. The notification occurs before the meeting organizer submits the proposed meeting for attempted scheduling of the proposed meeting.

### BRIEF DESCRIPTION OF THE DRAWINGS

FIG. 1 is a diagram of a method is provided for facilitating the scheduling of meeting resources within a calendar system, according to an example embodiment.

FIG. 2 is a diagram of another method for facilitating the scheduling of meeting resources within a calendar system, according to an example embodiment.

FIG. 3 is a diagram of a meeting resource scheduling system, according to an example embodiment.

### DETAILED DESCRIPTION

As used herein a “calendar application” and “calendar system” refer to a suite of executable software services that may or may not be integrated within an email client. A calendar application or calendar system is not a data calendar and is not a mere data structure; rather, it includes underlying executable software that uses and manipulates data structures, data calendars, etc. The phrases “calendar application” and “calendar system” can be used interchangeably and synonymously herein.

An email system includes one or more email servers that communicate with a plurality of email clients. Each user of an email system accesses the email system via an email client. In an embodiment, the calendar application or calendar system is integrated within the email clients and/or email services of an email system.

The phrase “meeting resource” includes a variety of assets used during meetings by people, such as meeting rooms, network connectivity equipment, video equipment, projector equipment, computers, laser pointers, audio equipment, conferencing equipment, etc. A meeting resource does not include people that attend meetings; people that attend meetings are referred to herein as “meeting attendees.”

According to an embodiment, the techniques presented herein are implemented in products associated and distributed by Novell®, Inc. of Provo, Utah.

Of course, the embodiments of the invention can be implemented in a variety of architectural platforms, emails systems, and/or calendar systems. Any particular architectural layout or implementation presented herein is provided for purposes of illustration and comprehension only and is not intended to limit various aspects of the invention.

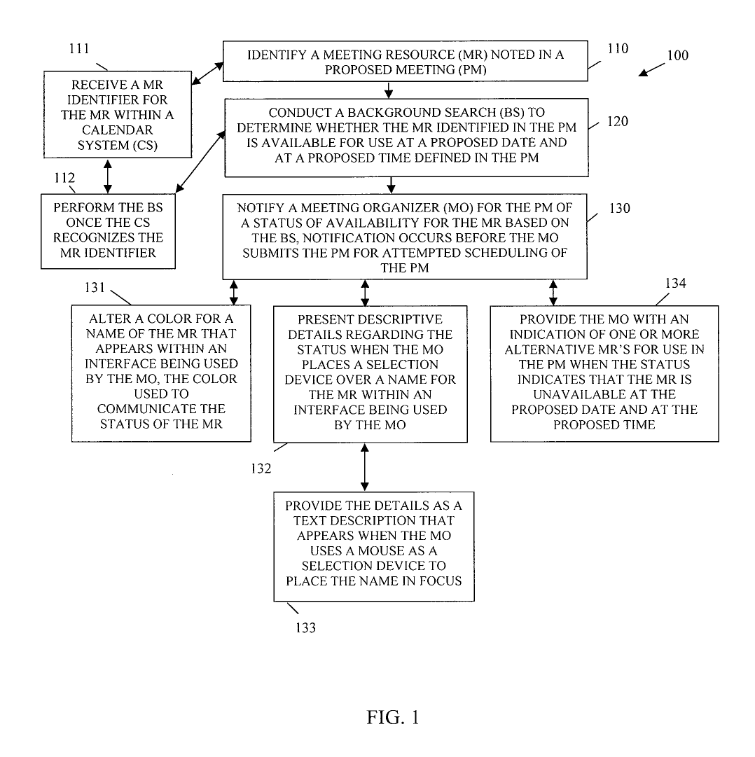

It is within this initial context, that various embodiments of the invention are now presented with reference to the FIGS. 1-4.

FIG. 1 is a diagram of a method 100 is provided for facilitating the scheduling of meeting resources within a calendar system, according to an example embodiment. The method 100 (hereinafter “meeting resource scheduling service”) is implemented as instructions in a machine-accessible and computer-readable medium. The instructions when executed by a machine (processing device, computer, etc.) perform the processing depicted in FIG. 1. The meeting resource scheduling service is also operational over and processes within a network. The network may be wired, wireless, or a combination of wired and wireless.

In an embodiment, the meeting resource scheduling service is implemented as an enhancement to a calendar system and is integrated within that calendar system.

At 110, the meeting resource scheduling service identifies a meeting resource that is noted in a proposed meeting that is being created within a calendar system. The meeting is “proposed” because a meeting organizer that is utilizing a calendar system interface has not yet submitted or committed the meeting for attempted scheduling. So, all the meeting organizer has done at this point in time is list or select the meeting resource as one of the members to include in the proposed meeting. Again, the meeting resource is not a meeting attendee or is not a human person that is attending the meeting.

According to an embodiment, at 111, the meeting resource scheduling service receives a meeting resource identifier for the meeting resource within the calendar system as was noted above at 110. The meeting resource identifier is a unique identifier for recognizing the meeting resource. The meeting organizer sees a descriptive name but the underlying automated processing converts or matches that descriptive name into a unique meeting resource identifier for processing.

Continuing with the embodiment at 111 and at 112, the meeting resource scheduling service performs a background search (discussed immediately below with the processing at 120) once the calendar system has recognized the meeting resource identifier.

At 120, the meeting resource scheduling service conducts a background search, such as a calendar system busy search, for purposes of determining whether the meeting resource noted and identified in the proposed meeting is available for use at a proposed date and at a proposed time defined in the proposed meeting by the meeting organizer who is interacting with a calendar system interface of the calendar system.

What is meant by “background search” is that the meeting organizer does not have to affirmatively conduct a calendar system search to determine the pre-availability of the meeting resource. The meeting resource scheduling service automatically and on behalf of the meeting organizer performs such a search, without any meeting organizer interaction, once the meeting resource is noted by the meeting organizer within the calendar system interface of the calendar system.

At 130, the meeting resource scheduling service notifies the meeting organizer for the proposed meeting of a status indicating an availability for the meeting resource based on the results of the background search. It is noted that this notification occurs before the meeting organizer actually submits the proposed meeting for attempted scheduling of the proposed meeting within the calendar system.

In other words, once a meeting organizer identifies or lists a meeting resource in a proposed meeting, the meeting resource scheduling service resolves whether that meeting resource is available at the proposed date and time on behalf of the meeting organizer and before the meeting organizer actually attempts to schedule the proposed meeting.

Notification by the meeting resource scheduling service can occur in a variety of manners.

For example, at 131, the meeting resource scheduling service alters a color for a name of the meeting resource that appears or is displayed within the calendar system interface being used by the meeting organizer. The color provides a unique visual indication for purposes of communicating the status of the meeting resource.

The status can include whether the meeting resource is available at the proposed time and proposed date and for a proposed duration of the proposed meeting or whether the meeting resource is unavailable. In an embodiment, a red color is used for a name of the meeting resource within the calendar system interface to indicate that the meeting resource is unavailable for the proposed meeting.

The status can also indicate more than just a binary communication to the meeting organizer (binary being available or unavailable). For example, the status may indicate that a resource has been reported as malfunctioning or needing service or that a resource is missing something normally expected to be present. The status may also include metadata that can be accessed by clicking the meeting resource name within the calendar system interface, the metadata may include additional details, such as contact person X to see if this is still available or to have it located in your meeting, etc.

In another case, at 132, the meeting resource scheduling service presents descriptive details regarding the status when the meeting organizer places a selection device over a name for the meeting resource within an interface being used by the meeting organizer.

So, if a computer is the device that is processing the meeting resource scheduling service, the selection device can be a mouse or a digital pen. If a personal digital assistant (PDA) or phone is the device that is processing the meeting resource scheduling service, then the selection device can be a wand or even a finger of the meeting organizer (for touch screen phones and PDA's). It should be noted that some computers are now equipped with touch screens so in these cases the selection device may be the finger of the meeting organizer as well.

Continuing with the embodiment at 132 and at 133, and in a specific implementation case of the meeting resource scheduling service, the meeting resource scheduling service provides the details as a text description that appears when the meeting organizer uses a mouse as the selection device to place the name of the meeting resource within focus inside the calendar system interface.

According to an embodiment, at 134, the meeting resource scheduling service provides the meeting organizer with an indication of one or more alternative meeting resources for use in the proposed meeting when the status of the meeting resource indicates that the chosen meeting resource is unavailable at the proposed date and at the proposed time of the proposed meeting.

It is now fully appreciated how meeting resources, such as meeting rooms and equipment for use in meeting rooms, can be more easily scheduled by meeting organizers within calendar systems.

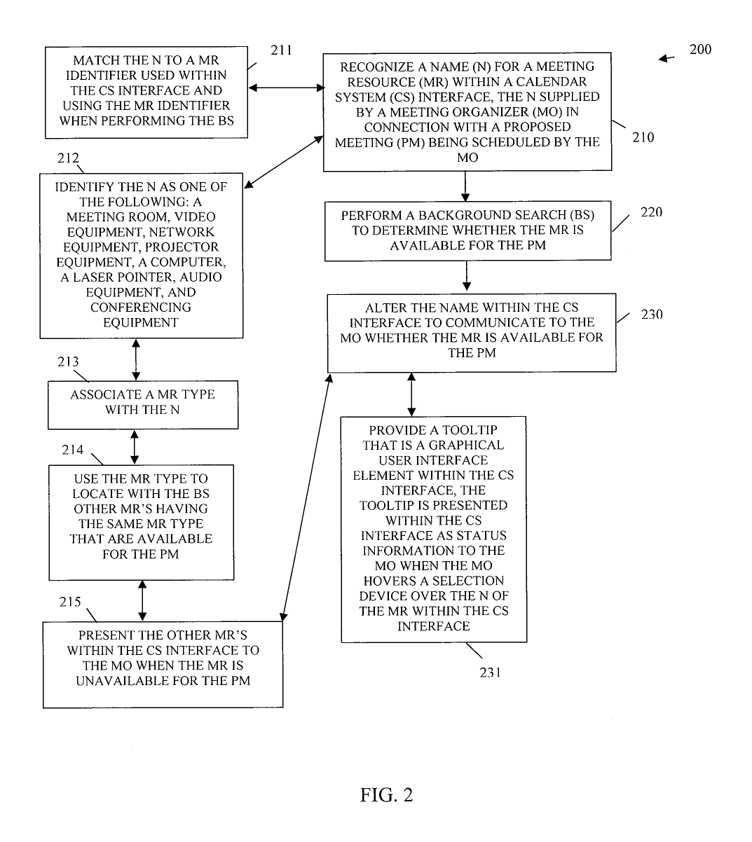

FIG. 2 is a diagram of another method 200 for facilitating the scheduling of meeting resources within a calendar system, according to an example embodiment. The method 200 (herein after referred to as “calendar service”) is implemented in and resides within a machine-accessible and computer-readable medium as instructions, which when accessed by a machine (one or more processors) performs the processing depicted in the FIG. 2. The calendar service is also operational over a network; the network may be wired, wireless, or a combination of wired and wireless.

The calendar service represents a processing perspective from within an email system or more particularly an email client of a particular user. Thus, the calendar service represents another and in some cases enhanced perspective of the meeting resource scheduling service represented by the method 100 of the FIG. 1.

At 210, the calendar service recognizes a name for a meeting resource within a calendar system interface. The name is supplied by a meeting organizer in connection with a proposed meeting being scheduled by the meeting organizer. The name is a text description that is easily recognized by the meeting organizer as to what the meeting resource is, such a meeting room, video equipment, network equipment, etc. The name is what appears in an address book or resource book available for the meeting organizer to use within a calendar system and its calendar system interface. In some cases, the address book and/or resource book is also available to an email system that is integrated within the calendar system.

According to an embodiment, at 211, the calendar service matches the name to a meeting resource identifier. The meeting resource identifier is used within the calendar system interface for automated processing that occurs on behalf of the meeting organizer within the calendar system when scheduling meetings. Also, the meeting resource identifier is used by the calendar service when performing a background search (discussed above with reference to the method 100 and discussed below with reference to the processing at 220).

In another case, at 212, the calendar service identifies the name as one of the following: a meeting room, video equipment, network equipment, projector equipment, a computer, a laser pointer, audio equipment, and conferencing equipment. In fact, the name is any physical resource that is non human and that is capable of being used by meeting attendees (people) during a meeting.

Continuing with the embodiment at 212 and at 213, the calendar service associates a meeting resource type with the name recognized by the calendar service at 210. This meeting resource type categorizes the meeting resource requested by the meeting organizer and can be used to locate or identify alternative meeting resources.

So, at 214, the calendar service uses the meeting resource type to locate with the background search (discussed below with reference to the processing at 220) other meeting resources having a same meeting resource type as the meeting resource. These other meeting resources are available for the proposed meeting that is attempting to be scheduled by the meeting organizer.

Continuing with the embodiment at 214 and at 215, the calendar service presents the other meeting resources (alternative meeting resources) within the calendar system interface to the meeting organizer when the meeting resource initially requested by the meeting organizer at 210 is unavailable for the proposed meeting, which the meeting organizer is attempting to schedule via the calendar service.

At 220, the calendar service performs a background search to determine whether the meeting resource is available for the proposed meeting. Here, the calendar system is used to search calendars maintained for meeting resources. Search of the calendars indicates whether the requested meeting resource is available at a proposed date and at a proposed time for the proposed meeting of the meeting organizer. This search is performed as soon as or when the meeting organizer supplies the meeting resource name within the calendar system interface. That is, the meeting organizer does not have to perform a calendar busy search manually; the calendar service does this dynamically and in real time on behalf of the meeting organizer once the meeting organizer supplies the name for the meeting resource within the calendar system interface.

At 230, the calendar service alters the name within the calendar system interface to communicate to the meeting organizer whether the meeting resource is available for the proposed meeting. Altercation of the name may be patently visible to the meeting organizer within the calendar system interface or may more subtly discoverable by the meeting organizer via minimal action on the part of the meeting organizer within the calendar system interface.

For example, at 231, the calendar service provides a tooltip feature within the calendar system interface to the meeting organizer. The tooltip is a graphical user interface (GUI) element integrated within the calendar system interface where the tooltip is presented within the calendar system interface as status information to the meeting organizer when the meeting organizers hovers, via a selection device, over the name of the meeting resource within the calendar system interface. Here, the meeting organizers moves a selection device over the name of the meeting resource within the calendar system interface and when focus is detected by the calendar service, status information is provided as a pop up graphical element within the calendar system interface. The status information can indicate availability or non availability of the meeting resource. The status information an also provide a variety of other information as discussed and presented above with reference to the method 100 of the FIG. 1.

It is also noted that other mechanisms, such as the ones discussed above with reference to the method 100 of the FIG. 1, can be used to alter the name either directly or subtly to communicate to the meeting organizer status information with respect to the meeting resource.

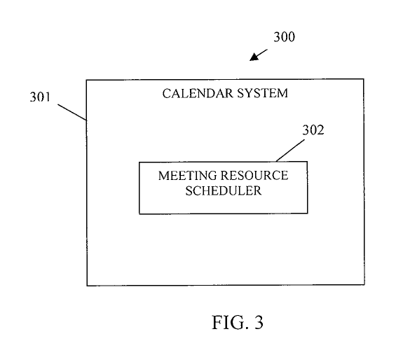

FIG. 3 is a diagram of a meeting resource scheduling system 300, according to an example embodiment. The meeting resource scheduling system 300 is implemented in and resides within a machine-accessible and computer-readable storage medium as instructions, which when accessed by a machine (computer, one or more processors, or processor-enabled device) performs, among other things, the processing depicted in the methods 100 and 200 of the FIGS. 1 and 2, respective. The meeting resource scheduling system 300 is also operational over a network; the network may be wired, wireless, or a combination of wired and wireless.

The meeting resource scheduling system 300 includes a calendar system 301 and a meeting resource scheduler 302. Each of these components and their interactions with one another will now be discussed in turn.

The calendar system 301 is implemented in a computer-readable medium and executes on multiple processing devices of the network. The calendar system 301 is an enhanced and improved version of existing calendar systems or is a newly developed calendar system 301 designed to perform the features presented herein. Example aspects of the calendar system 301 were presented above in detail with reference to the methods 100 and 200 of the FIGS. 1 and 2, respectively.

The calendar system 301 includes a calendar system interface, which meeting organizers use to schedule meetings having meeting attendees (people) and meeting resources (meeting rooms and meeting room equipment).

In an embodiment, the calendar system 301 is integrated within an email system. In some cases, the email system is enabled over the World-Wide Web (WWW) as a series of accessible WWW pages available over the Internet.

The calendar system interface is configured to receive meeting resources for scheduling meetings (via meeting resource names and identifiers supplied by a meeting organizer via interaction with the calendar system interface when scheduling meetings).

The meeting resource scheduler 302 is implemented in a computer-readable storage medium and executes within the calendar system 301 and on the multiple processing devices of the calendar system 301. Detailed aspects of the meeting resource scheduler 302 were presented above with reference to the methods 100 and 200 of the FIGS. 1 and 2, respectively.

The meeting resource scheduler 302 is configured to recognize meeting resources in proposed meetings that are being scheduled within the calendar system 301 via the calendar system interface by meeting organizers.

The meeting resource scheduler 302 is also configured to perform a background search of calendars maintained within the calendar system 301 to determine the availability of the meeting resources before the proposed meetings are attempted to be scheduled within the calendar system 301 by the meeting organizers.

According to an embodiment, the meeting resource scheduler 302 is also integrated within email clients of an email system, where the calendar system 301 is also integrated within that email system.

In another case, the meeting resource scheduler 302 includes a tooltip service. The tooltip service is implemented and resides within a computer-readable storage medium and executes with the meeting resource scheduler 302. Furthermore, the tooltip service is configured to notify meeting organizers of statuses regarding availability of the meeting resources within the calendar system interface of the calendar system 301. These notifications occur before meetings are actually attempted to be scheduled by the meeting organizers within the calendar system 301.

In yet another situation, the meeting resource scheduler 302 is further configured to suggest alternative meeting resources for the meeting resources initially requested by meeting organizers when the initially requested meeting resources are unavailable for proposed meetings. Moreover, the alternative meeting resources are of a same type or class of resource as the initially requested meeting resources. So, the meeting organizers can have backup meeting resources when requested meeting resources are unavailable for proposed meetings that the meeting organizers are attempting to schedule within the calendar system 301.

It is now fully appreciated how meeting resources can be more efficiently scheduled within calendar systems than what has been provided in the past. These meeting resources are meeting rooms or equipment used by people in meetings; the meeting resources are not meeting attendees (people). By integrating meeting resources into calendar systems and by conducting background busy searches in an automated fashion on behalf of meeting organizers, meeting organizers can experience improved efficiency in scheduling meetings.

The calendar systems can be stand alone calendar systems or can be calendar systems that are integrated into email systems. Moreover, as stated above, the calendar systems can be application and client based and/or WWW enabled.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method to execute on a processor, the method comprising:
identifying a meeting resource noted in a proposed meeting;
conducting a background search to determine whether the meeting resource identified in the proposed meeting is available for use at a proposed date and at a proposed time defined in the proposed meeting; and
notifying a meeting organizer for the proposed meeting of a status of availability for the meeting resource based on the background search, notification occurs before the meeting organizer submits the proposed meeting for attempted scheduling of the proposed meeting.

2. The method of claim 1, wherein identifying further includes receiving a meeting resource identifier for the meeting resource within a calendar system.

3. The method of claim 2, wherein conducting further includes performing the background search once the calendar system recognizes the meeting resource identifier.

4. The method of claim 1, wherein notifying further includes altering a color for a name of the meeting resource that appears within an interface being used by the meeting organizer, the color used to communicate the status of the meeting resource.

5. The method of claim 1, wherein notifying further includes presenting descriptive details regarding the status when the meeting organizer places a selection device over a name for the meeting resource within an interface being used by the meeting organizer.

6. The method of claim 5, wherein presenting further includes providing the details as a text description that appears when the meeting organizer uses a mouse as a selection device to place the name in focus.

7. The method of claim 1, wherein notifying further includes providing the meeting organizer with an indication of one or more alternative meeting resources for use in the proposed meeting when the status indicates that the meeting resource is unavailable at the proposed date and at the proposed time.

8. A machine-implemented method to execute on a processor, the method comprising:
recognizing a name for a meeting resource within a calendar system interface, the name supplied by a meeting organizer in connection with a proposed meeting being scheduled by the meeting organizer;
performing a background search to determine whether the meeting resource is available for the proposed meeting;
altering the name within the calendar system interface to communicate to the meeting organizer whether the meeting resource is available for the proposed meeting.

9. The method of claim 8, wherein recognizing further includes matching the name to a meeting resource identifier used within the calendar system interface and using the meeting resource identifier when performing the background search.

10. The method of claim 8, wherein recognizing further includes identifying the name as one of the following: a meeting room, video equipment, network equipment, projector equipment, a computer, a laser pointer, audio equipment, and conferencing equipment.

11. The method of claim 10, wherein recognizing further includes associating a meeting resource type with the name.

12. The method of claim 11 further comprising, using the meeting resource type to locate with the background search other meeting resources having the same meeting resource type that are available for the proposed meeting.

13. The method of claim 12, wherein altering further includes presenting the other meeting resources within the calendar system interface to the meeting organizer when the meeting resource is unavailable for the proposed meeting.

14. The method of claim 8, wherein altering further includes providing a tooltip that is a graphical user interface element within the calendar system interface, the tooltip is presented within the calendar system interface as status information to the meeting organizer when the meeting organizer hovers a selection device over the name of the meeting resource within the calendar system interface.

15. A machine-implemented system, comprising:
a calendar system implemented in a computer-readable medium and to execute on multiple processing devices of a network; and
a meeting resource scheduler implemented in a computer-readable medium and to execute within the calendar system and on the multiple processing devices;
wherein the calendar system includes a calendar system interface, the calendar system interface is configured to receive meeting resources for scheduling meetings, the meeting resource scheduler is configured to recognize meeting resources in proposed meetings that are being scheduled within the calendar system interface and the further configured to perform a background search to determine the availability of the meeting resources before the proposed meetings are attempted to be scheduled.

16. The system of claim 15, wherein the calendar system is integrated within an email system.

17. The system of claim 16, wherein the meeting resource scheduler is integrated within email clients of the email system.

18. The system of claim 16, wherein the email system is World-Wide Web (WWW) enabled via WWW pages over the Internet.

19. The system of claim 15, wherein the meeting resource scheduler includes a tool tip service implemented in a computer-readable medium and to execute with the meeting resource scheduler, the tool tip service is configured to notify meeting organizers of statuses regarding availability of the meeting resources within the calendar system interface before the proposed meetings are attempted to be scheduled within the calendar system.

20. The system of claim 15, wherein the resource schedule is further configured to suggest alternative meeting resources for the meeting resources when the meeting resources are unavailable for the proposed meetings, the alternative meeting resources are of a same type of resource as the meeting resources.
